(19) United States
(12) Patent Application Publication
(10) Pub. No.: US 2025/0004257 A1
(43) Pub. Date: Jan. 2, 2025

(54) LENS DEVICE AND ELECTRONIC DEVICE

(71) Applicant: AAC OPTICS (CHANGZHOU) CO., LTD., Changzhou City (CN)

(72) Inventors: Chengxi Li, Changzhou (CN); Chuandong Wei, Changzhou (CN); Rongbao Shi, Changzhou (CN)

(21) Appl. No.: 18/399,625

(22) Filed: Dec. 28, 2023

Related U.S. Application Data
(63) Continuation of application No. PCT/CN2023/104769, filed on Jun. 30, 2023.

(51) Int. Cl. G02B 13/00; G02B 7/02

(52) U.S. Cl. CPC G02B 13/0065; G02B 7/021

(57) ABSTRACT

A lens device and an electronic device. The lens device includes a first lens group, a second lens group and a prism. An optical axis of the first lens group is arranged at an angle with respect to an optical axis of the second lens group, an optical path of the first lens group is closer to an object side than an optical path of the second lens group, and the prism is arranged between the first lens group and the second lens group and configured to change an optical path. An edge of at least one lens in the first lens group and the second lens group includes a cut edge. Radial dimensions of the first lens group and the second lens group are reduced, better hiding the lens device into the black edge of the display screen and facilitating the full-screen design of the display screen.

### CROSS-REFERENCE TO RELATED APPLICATIONS

This application is a continuation of International Application No. PCT/CN2023/104769, filed on Jun. 30, 2023, which is hereby incorporated by reference in its entirety.

### TECHNICAL FIELD

The present disclosure relates to the technical field of cameras, and in particular, to a lens device and an electronic device.

### BACKGROUND

With the continuous development of science and technology, electronic devices continuously focus on development in terms of intelligence. In addition to digital cameras, portable electronic devices (such as tablet computers, and mobile phones) are also provided with lens modules with photographing functions to meet requirements of users to take photos anytime. However, a front lens of the mobile phone usually has a large radial dimension, thus it is difficult to hide the front lens of the mobile phone into a black edge of a screen, thereby failing to achieve an actual full-screen and significantly impacting user experience.

Therefore, it needs to provide a lens device and an electronic device to solve the above-mentioned technical problems.

### SUMMARY

An object of the present disclosure is to provide a lens device and an electronic device, aiming to solve the technical problem that it is difficult to hide a front lens of a mobile phone into a black edge of a screen due to a generally large radial dimension of the front lens.

In an aspect, an embodiment of the present disclosure provides a lens device, including: a first lens group; a second lens group; and a prism. An optical axis of the first lens group is arranged at an angle with respect to an optical axis of the second lens group, an optical path of the first lens group is arranged closer to an object side than an optical path of the second lens group, and the prism is arranged between the first lens group and the second lens group and configured to change an optical path. An edge of at least one lens in the first lens group and the second lens group includes a cut edge.

As an improvement, the optical axis of the first lens group is perpendicular to the optical axis of the second lens group.

As an improvement, the first lens group includes a first lens barrel and first lenses arranged in the first lens barrel, the second lens group includes a second lens barrel and second lenses arranged in the second lens barrel, the prism is arranged in the second lens barrel, and the first lens barrel is adhered to the second lens barrel through an adhesive, such that the optical axis of the first lens group is arranged at a preset angle with respect to the optical axis of the second lens group.

As an improvement, at least one of the first lenses includes a first cut edge and a second cut edge opposite to each other, and at least one of the second lenses includes a third edge and a fourth edge opposite to each other.

As an improvement, the first lens barrel is provided therein with a first step hole, at step walls of which the first lenses are received; the second lens barrel is provided therein with a second step hole, at step walls of which the second lenses are received. The second lens barrel is further provided with a receiving groove communicating with the second step hole, and the prism is received in the receiving groove.

As an improvement, the second lens barrel is provided with a notch, and the first lens barrel is received at the notch.

As an improvement, three first lenses and two second lenses are provided.

As an improvement, the prism is a planar prism or an aspherical-surface prism.

In another aspect, an embodiment of the present disclosure provides an electronic device, including a housing, a display screen and a lens device. The lens device includes: a first lens group; a second lens group; and a prism. An optical axis of the first lens group is arranged at an angle with respect to an optical axis of the second lens group, an optical path of the first lens group is arranged closer to an object side than an optical path of the second lens group, and the prism is arranged between the first lens group and the second lens group and configured to change an optical path. An edge of at least one lens in the first lens group and the second lens group includes a cut edge. The optical axis of the first lens group is perpendicular to the display screen, and is arranged close to an inner wall of the display screen and an inner wall of the housing.

As an improvement, the electronic device is a mobile phone.

### BRIEF DESCRIPTION OF DRAWINGS

FIG. 1 is a schematic diagram of installation of a camera device on an electronic device in the prior art.

FIG. 2 is a schematic diagram of installation of a camera device on an electronic device according to an embodiment of the present disclosure.

FIG. 3 is a schematic diagram of installation of a camera device on an electronic device according to another embodiment of the present disclosure.

FIG. 4 is a schematic diagram of a camera device according to an embodiment of the present disclosure.

FIG. 5 is an exploded view of the camera device shown in FIG. 4.

FIG. 6 is an exploded view of a first lens group of the camera device shown in FIG. 5.

FIG. 7 is an exploded view of a second lens group and a prism in the camera device shown in FIG. 5.

FIG. 8 is a schematic diagram of a camera device according to another embodiment of the present disclosure.

FIG. 9 is an exploded view of the camera device shown in FIG. 8.

FIG. 10 is an exploded view of a first lens group of the camera device shown in FIG. 9.

FIG. 11 is an exploded view of a second lens group and a prism in the camera device shown in FIG. 9.

FIG. 12 is a schematic diagram of an electronic device according to an embodiment of the present disclosure.

### REFERENCE SIGNS

10. lens device;
20. display screen;
21. black edge;
22. display area;
23. lens opening;
30. housing;
100. first lens group;
110. first lens barrel;
111. first step hole;
120. first lens;
121. 1^{st} first lens;
122. 2^{nd} first lens;
123. 3^{rd} first lens;
101. first cut edge;
102. second cut edge;
200. second lens group;
210. second lens barrel;
211. second step hole;
212. receiving groove;
213. notch;
220. second lens;
221. 1^{st} second lens;
222. 2^{nd} second lens;
201. third cut edge;
202. fourth cut edge;
230. optical lens;
300. prism;
310. first optical surface;
311. aspherical surface;
320. second optical surface;
330. third optical surface;
410. adhesive;
420. light shielding sheet.

### DESCRIPTION OF EMBODIMENTS

The present disclosure is further described below with reference to the drawings and embodiments.

Apparently, the described embodiments are merely some of rather than all of the embodiments of the present disclosure. All other embodiments obtained by those skilled in the art based on the embodiments of the present disclosure without creative efforts shall fall into a scope of the present disclosure.

It should be noted that similar reference signs and letters represent similar terms in the drawings, and therefore, once an item is defined in a drawing, there is no need for further definition and explanation in the following drawings.

In the description of the present disclosure, it should be noted that, if the terms “upper”, “lower”, “inner”, and “outer” indicate an orientation or position relationship based on the orientation or position relationship shown in the drawings, or an orientation or position relationship conventionally arranged when using the product of the present disclosure, it is merely for convenience in describing the present disclosure and simplifying the description, rather than indicating or implying that the device or element must have a specific orientation, or must have a specific construction or a specific operation in a specific orientation, and therefore shall not be illustrated as a limitation on the present disclosure.

In addition, if the terms “1^{st}/first”, “2^{nd}/second”, . . . are used to distinguish descriptions merely, it cannot be illustrated as indicating or implying relative importance thereof.

It should be noted that features in the embodiments of the present disclosure can be combined with each other without conflict.

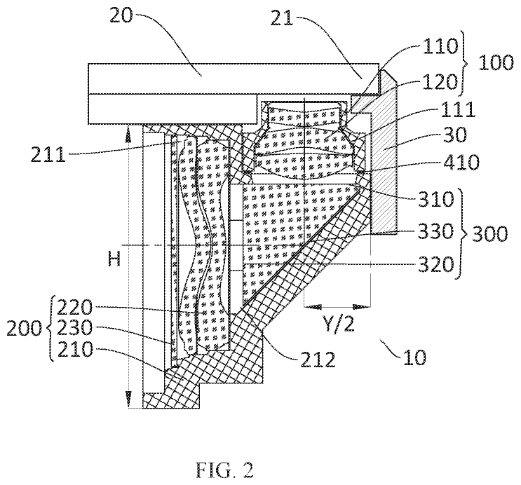

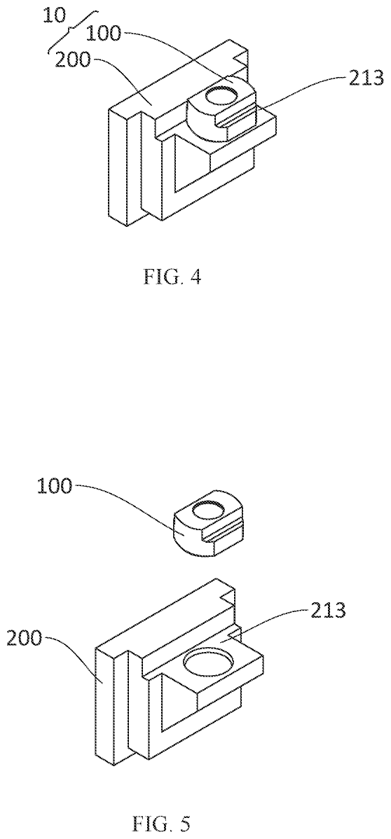

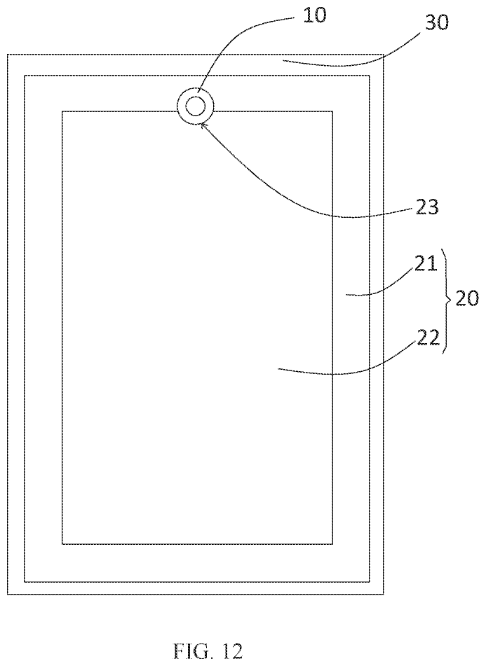

In an aspect, an embodiment of the present disclosure provides an electronic device, which may be a mobile terminal such as a mobile phone or a tablet computer. Referring to FIG. 2 to FIG. 12, the electronic device includes a housing 30, a display screen 20 and a lens device 10. The display screen 20 includes a display area 22 and a black edge 21 disposed outside the display area 22, and the black edge 21 is a non-display area. The display screen 20 has a lens opening 23 corresponding to the lens device 10, the lens opening 23 is located at a side of the display screen 20, and at least part of the lens opening 23 is located in the black edge 21, so that an area of the lens opening 23 in the display area 22 is reduced or the lens opening 23 may even be completely located in the black edge 21. In this way, a full-screen of the electronic device can be achieved.

The lens device 10 includes a first lens group 100, a second lens group 200 and a prism 300. An optical axis of the first lens group 100 is arranged at an angle with respect to an optical axis of the second lens group 200, and an optical path of the first lens group 100 is arranged closer to an object side than an optical path of the second lens group 200. The prism 300 is arranged between the first lens group 100 and the second lens group 200, and is configured to change the optical path.

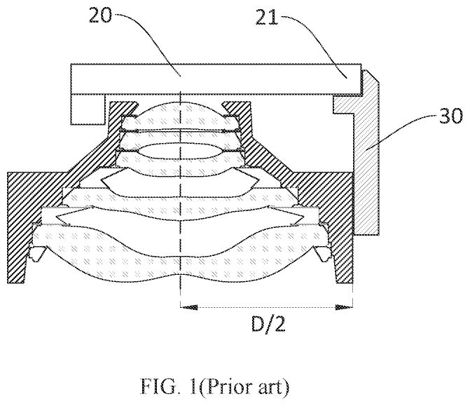

FIG. 1 shows installation of the camera device on the electronic device in the prior art, where a dimension of D/2 is relatively large, making it difficult to hide the camera device into the black edge 21 of the display screen 20.

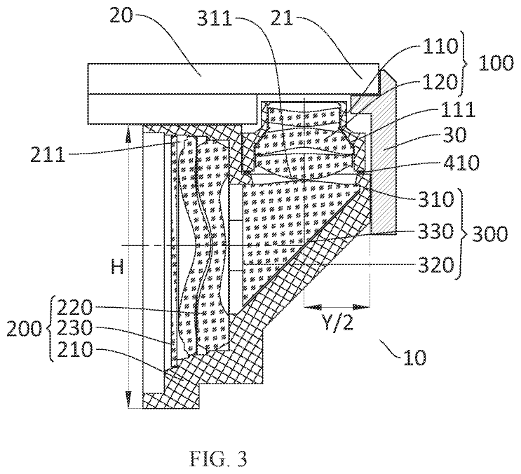

In this embodiment of the present disclosure, since the prism 300 is arranged between the first lens group 100 and the second lens group 200, a height dimension of the lens device 10 can be reduced by using the prism 300 to change the optical path, facilitating the lightness and thinness deign of the electronic device. The lens device 10 is divided into the first lens group 100 and the second lens group 200, and since a radial dimension of the first lens group 100 close to the object side is smaller than a radial dimension of the second lens group 200, as shown in FIG. 2 and FIG. 3, a dimension of Y/2 is greatly reduced, thereby reducing an installation dimension adapted to the display screen 20 and thus better hiding the lens device 10 into the black edge 21 of the display screen 20. In this way, the dimension of the display area 22 on the display screen 20 can be increased, thereby facilitating the full-screen design of the display screen 20 and improving the user experience.

Further, in an embodiment of the present disclosure, an edge of at least one lens in the first lens group 100 and the second lens group 200 is provided with a cut edge, thereby reducing a radial dimension of the lens in the lens group. In this way, a radial dimension of the first lens group 100 and the second lens group 200 can be further reduced. Referring to FIG. 2 and FIG. 3, the dimension of H is greatly reduced, thereby further reducing an installation dimension adapted to the display screen 20. In this way, the lens device 10 can be arranged closer to or even hidden into the black edge 21 of the display screen 20.

In an embodiment, referring to FIG. 2 and FIG. 3, the optical axis of the first lens group 100 is perpendicular to the display screen 20, and is arranged close to an inner wall of the display screen 20 and an inner wall of the housing 30, thereby reducing the installation dimension of the first lens group 100, the display screen 20, and the housing 30. In this way, the lens device 10 can be better hidden into the black edge 21 of the display screen 20.

Further, in this embodiment, the optical axis of the first lens group 100 and the optical axis of the second lens group 200 are perpendicular to each other, thereby facilitating the installation of the lens device 10 in the housing 30 and the display screen 20, and further facilitating the lightness and thinness design of the electronic device. For example, the electronic device may be a mobile phone, thereby facilitating a full-screen design and the lightness and thinness design of the mobile phone.

In some embodiments, the optical axis of the first lens group 100 may be arranged at an acute angle or an obtuse angle with respect to the display screen 20, and the optical axis of the first lens group 100 may further be arranged at an acute angle or an obtuse angle with the optical axis of the second lens group 200.

In an embodiment, further referring to FIG. 2 and FIG. 3, the first lens group 100 includes a first lens barrel 110, and a plurality of first lenses 120 arranged in the first lens barrel 110. Each of the plurality of first lenses 120 is installed in the first lens barrel 110, thereby facilitating integrated assembly of the plurality of first lenses 120.

In an embodiment, the second lens group 200 includes a second lens barrel 210 and a plurality of second lenses 220 arranged in the second lens barrel 210. Each of the plurality of second lenses 220 is installed in the second lens barrel 210, thereby facilitating integrated assembly of the second lenses 220.

Further, the prism 300 is arranged in the second lens barrel 210, and the first lens barrel 110 is adhered to the second lens barrel 210 through an adhesive 410, so that the optical axis of the first lens group 100 is arranged at a preset angle with respect to the optical axis of the second lens group 200.

By adjusting an adhering position of the first lens barrel 110 and the second lens barrel 210, an angle between the optical axis of the first lens group 100 and the optical axis of the second lens group 200 can be adjusted, thereby facilitating assembly of the first lens group 100 and the second lens group 200.

In this embodiment, there are three first lenses 120 and two second lenses 220, so that the lens device 10 is configured as a five-lenses module. The height and the radial dimension of the lens module can be reduced with fewer lenses, thereby facilitating miniaturization, lightness and thinness deign of the electronic device.

In some embodiments, one first lens 120, two first lenses 120, four first lenses 120, or more first lenses 120 may be provided, and one second lens 220, three second lenses 220, or more second lenses 220 may be provided, so that the lens device 10 is configured as a six-lenses module, a seven-lenses module, or the like according to actual requirements.

In an embodiment, further referring to FIG. 3, the prism 300 is an aspherical-surface prism 300. An aspherical surface 311 is provided at the prism 300, thereby improving an optical performance of the lens device 10.

Further, the prism 300 includes a first optical surface 310, a second optical surface 320 perpendicular to the first optical surface 310, and a third optical surface 330 arranged at an acute angle with respect to each of the first optical surface 310 and the second optical surface 320. At least one of the first optical surface 310 and the second optical surface 320 is provided with an aspherical surface 311.

In an example, the optical axis of the first optical surface 310 and the optical axis of the first lens barrel 110 are arranged coaxially, the optical axis of the second optical surface 320 and the optical axis of the second lens barrel 210 are arranged coaxially, and the aspherical surface 311 is provided at the first optical surface 310.

In some other embodiments, referring to FIG. 2, the prism 300 may be a planar prism 300, that is, each of the first optical surface 310 and the second optical surface 320 is a flat optical surface, or the second optical surface 320 of the prism 300 is an aspherical surface 311, and the optical surface in the prism 300 may be configured according to design requirements of the lens module to ensure the optical performance of the lens device.

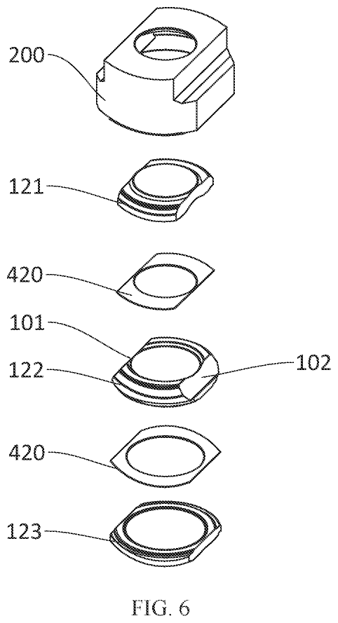

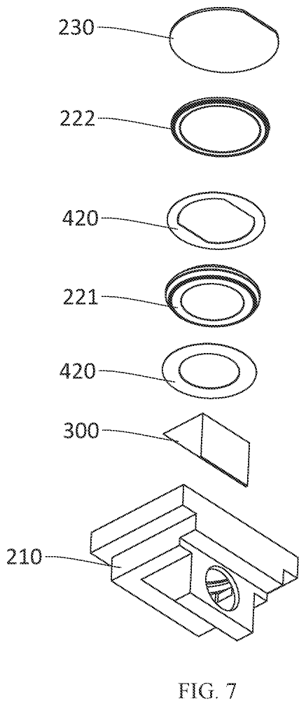

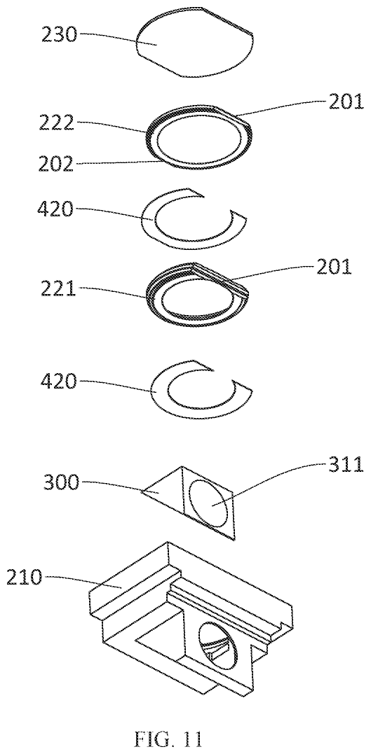

In an embodiment, referring to FIG. 6 and FIG. 7, FIG. 10 and FIG. 11, at least one of the first lenses 120 is provided with a first cut edge 101 and a second cut edge 102 opposite to each other, and at least one of the second lenses 220 is provided with a third cut edge 201 and a fourth cut edge 202 opposite to each other, thereby reducing a radial dimension of the lens in the lens group, and thus further reducing radial dimensions of the first lens group 100 and the second lens group 200. In this way, an installation dimension adapted to the display screen 20 can be further reduced.

In this embodiment, each lens of the first lens group 100 and each lens of the second lens group 200 may have various solutions in terms of the cut edge to adapt to installation of the lens device 10 on the electronic device.

In an embodiment, referring to FIG. 10 and FIG. 11, the first lens group 100 includes three first lenses 120, namely a 1^{st} first lens 121, a 2^{nd} first lens 122, and a 3^{rd} first lens 123. The 1^{st} first lens 121, the 2^{nd} first lens 122, and the 3^{rd} first lens 123 each are provided with a first cut edge 101 and a second cut edge 102 opposite to each other. The second lens group 200 includes two second lenses 220, namely a 1^{st} second lens 221 and a 2^{nd} second lens 222. The 1^{st} second lens 221 is provided with a third cut edge 201 at one side, and the 2^{nd} second lens 222 is provided with a third cut edge 201 and a fourth cut edge 202 opposite to each other. In this way, radial dimensions of the lenses can be reduced, thereby facilitating the lightness and thinness deign of the lens device 10. Meanwhile, installation dimensions of the first lens group 100, and the display screen 20 and the housing 30 can be reduced, thereby better hiding the lens device 10 into the black edge 21 of the display screen 20.

In another embodiment, the first lens group 100 includes three first lenses 120, namely a 1^{st} first lens 121, a 2^{nd} first lens 122, and a 3^{rd} first lens 123. The 1^{st} first lens 121, the 2^{nd} first lens 122 and the 3^{rd} first lens 123 each are provided with a first cut edge 101 and a second cut edge 102 opposite to each other. The second lens group 200 includes two second lenses 220, namely a 1^{st} second lens 221 and a 2^{nd} second lens 222. The 1^{st} second lens 221 and the 2^{nd} second lens 222 each are provided with a third cut edge 201 and a fourth cut edge 202 opposite to each other. In this way, radial dimensions of the lenses can be reduced, thereby facilitating the lightness and thinness deign of the lens device 10. Meanwhile, installation dimensions of the first lens group 100, and the display screen 20 and the housing 30 can be reduced, thereby better hiding the lens device 10 into the black edge 21 of the display screen 20.

In another embodiment, the first lens group 100 includes three first lenses 120, namely a 1^{st} first lens 121, a 2^{nd} first lens 122, and a 3^{rd} first lens 123. The 1^{st} first lens 121, the 2^{nd} first lens 122 and the 3^{rd} first lens 123 each are provided with a first cut edge 101 and a second cut edge 102 opposite to each other. The second lens group 200 includes three second lenses 220, namely a 1^{st} second lens 221, a 2^{nd} second lens 222 and a 3^{rd} second lens. The 1^{st} second lens 221, the 2^{nd} second lens 222 and the 3^{rd} second lens each are provided with a third cut edge 201 and a fourth cut edge 202 opposite to each other. In this way, radial dimensions of the lenses can be reduced, thereby facilitating the lightness and thinness deign of the lens device 10. Meanwhile, installation dimensions of the first lens group 100, and the display screen 20 and the housing 30 can be reduced, thereby better hiding the lens device 10 into the black edge 21 of the display screen 20.

In other embodiments, the lenses in the lens device 10 may have configuration in terms of the cut edge. For example, referring to FIG. 6 and FIG. 7, the first lens group 100 includes three first lenses 120, namely a 1st first lens 121, a 2^{nd} first lens 122 and a 3^{rd} first lens 123. The 1^{st} first lens 121, the 2^{nd} first lens 122, and the 3^{rd} first lens 123 each are provided with a first cut edge 101 and a second cut edge 102 opposite to each other. The second lens group 200 includes two second lenses 220, namely a 1^{st} second lens 221 and a 2^{nd} second lens 222. The 1^{st} second lens 221 and the 2^{nd} second lens 222 each are provided with a cut edge. In this way, the optical performance of the lens device 10 can be guaranteed. Therefore, it should be noted that the respective edges of the lenses in the lens device 10 are cut to minimize the dimension of the first lens group 100 and the second lens group 200 in the lens device 10 under a premise that the optical performance of the lenses in the lens device 10 should not be affected.

In an embodiment, referring to FIG. 2 and FIG. 3, the first lens barrel 110 is provided therein with a first step hole 111, and the first lens 120 is received at a step hole wall of the first step hole 111; and the second lens barrel 210 is provided therein with a second step hole 211, and the second lens 220 is received at a step hole wall of the second step hole 211. The second lens barrel 210 is further provided with a receiving groove 212 communicating with the second step hole 211, and the prism 300 is received in the receiving groove 212. In this way, installation of the first lenses 120, the second lenses 220, and the prism 300 is achieved.

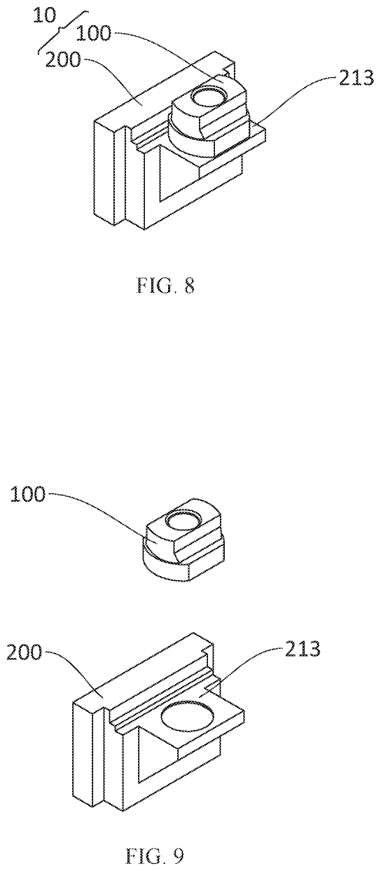

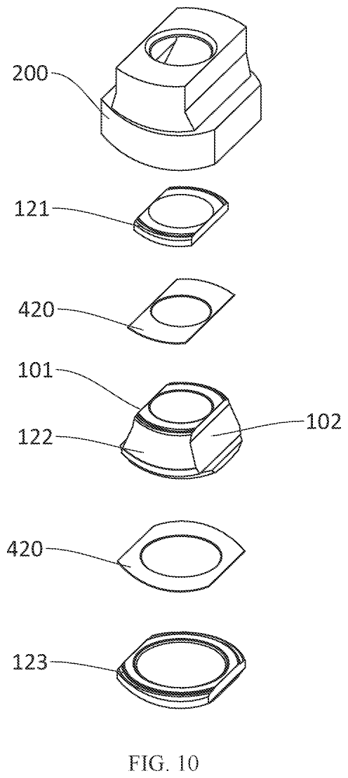

In an embodiment, referring to FIG. 2 to FIG. 5, FIG. 8 and FIG. 9, the second lens barrel 210 is provided with a notch 213, and the first lens barrel 110 is received at the notch 213, thereby facilitating miniaturization of the lens device 10. In an example, light shielding sheets 420 are further provided in the first lens group 100 and the second lens group 200, and each of the light shielding sheets 420 is arranged between two adjacent lenses, meanwhile, edges of the light shielding sheets 420 are adaptively cut according to the cut edges of the lenses. Further, an optical lens 230 is further provided in the second lens group 200, and the optical lens 230 is configured to limit each second lens 220 inside the second lens barrel 210.

The above description merely describes some embodiments of the present disclosure, and it should be noted that those skilled in the art can also make improvements without departing from a concept of the present disclosure, but all of these improvements shall fall within a scope of the present disclosure.

What is claimed is:

1. A lens device, comprising:
a first lens group;
a second lens group; and
a prism,
wherein an optical axis of the first lens group is arranged at an angle with respect to an optical axis of the second lens group, an optical path of the first lens group is arranged closer to an object side than an optical path of the second lens group, and the prism is arranged between the first lens group and the second lens group and configured to change an optical path; and
wherein an edge of at least one lens in the first lens group and the second lens group comprises a cut edge.

2. The lens device as described in claim 1, wherein the optical axis of the first lens group is perpendicular to the optical axis of the second lens group.

3. The lens device as described in claim 1, wherein the first lens group comprises a first lens barrel and first lenses arranged in the first lens barrel, the second lens group comprises a second lens barrel and second lenses arranged in the second lens barrel, the prism is arranged in the second lens barrel, and the first lens barrel is adhered to the second lens barrel through an adhesive, such that the optical axis of the first lens group is arranged at a preset angle with respect to the optical axis of the second lens group.

4. The lens device as described in claim 3, wherein at least one of the first lenses comprises a first cut edge and a second cut edge opposite to each other, and at least one of the second lenses comprises a third edge and a fourth edge opposite to each other.

5. The lens device as described in claim 3, wherein the first lens barrel is provided therein with a first step hole, at step walls of which the first lenses are received; the second lens barrel is provided therein with a second step hole, at step walls of which the second lenses are received; and wherein the second lens barrel is further provided with a receiving groove communicating with the second step hole, and the prism is received in the receiving groove.

6. The lens device as described in claim 3, wherein the second lens barrel is provided with a notch, and the first lens barrel is received at the notch.

7. The lens device as described in claim 3, wherein three first lenses and two second lenses are provided.

8. The lens device as described in claim 1, wherein the prism is a planar prism or an aspherical-surface prism.

9. An electronic device, comprising a housing, a display screen and a lens device,
wherein the lens device comprises:
a first lens group;
a second lens group; and
a prism,
wherein an optical axis of the first lens group is arranged at an angle with respect to an optical axis of the second lens group, an optical path of the first lens group is arranged closer to an object side than an optical path of the second lens group, and the prism is arranged between the first lens group and the second lens group and configured to change an optical path;
wherein an edge of at least one lens in the first lens group and the second lens group comprises a cut edge; and
wherein the optical axis of the first lens group is perpendicular to the display screen, and is arranged close to an inner wall of the display screen and an inner wall of the housing.

10. The electronic device as described in claim 9, wherein the electronic device is a mobile phone.
